(19) United States
(12) Patent Application Publication
(10) Pub. No.: US 2025/0094258 A1
(43) Pub. Date: Mar. 20, 2025

(54) SYSTEMS AND METHODS FOR DETERMINING AN APPLICATION MIGRATION PLAN

(71) Applicant: JPMORGAN CHASE BANK, N.A., New York, NY (US)

(72) Inventor: Colin FINDLAY, Motherwell (GB)

(21) Appl. No.: 18/891,897

(22) Filed: Sep. 20, 2024

Related U.S. Application Data
(60) Provisional application No. 63/584,043, filed on Sep. 20, 2023.

(51) Int. Cl. G06F 9/54; G06F 16/21; G06F 16/901

(52) U.S. Cl. CPC G06F 9/547; G06F 16/214; G06F 16/9024

(57) ABSTRACT

In some embodiments, the techniques described herein relate to a method including: collecting metadata from one or more data sources, the metadata including connections between a plurality of applications and one or more of a plurality of platform services; storing the metadata in a graph structure on a memory, wherein the graph structure includes a node for each application and platform service and an edge for a connection between each application and each platform service; and identifying a plurality of tranches of the graph structure, wherein a first tranche of the plurality of tranches includes a first application of the plurality of applications connected to a first platform service of the plurality of platform services.

### RELATED APPLICATIONS

This application claims the benefit of U.S. Provisional Patent Application Ser. No. 63/584,043, filed Sep. 20, 2023. The disclosure of which is hereby incorporated, by reference, in its entirety.

### BACKGROUND

### 1. Field of the Invention

Embodiments generally relate to systems and methods for determining an application migration plan.

### 2. Description of the Related Art

Moving large applications to a public cloud is a challenge that is faced by development teams. An application may include many microservices (e.g., small, loosely coupled, component applications that, in the aggregate, comprise the end-user application), and each microservice may have one or more dependency services that are required for the microservice to execute properly. This can result in a large number of dependencies that must be considered and provisioned prior to application migration. Merely understanding the required dependencies can be a time-consuming endeavor. Conventionally, planning for and provisioning dependencies for an application migration may require an immense amount of time and resources. There is a need for an efficient application migration system that takes into account and resolves large numbers of dependencies to reduce or eliminate extensive manual labor currently required.

The large number of dependencies of applications and microservices create significant challenges when migrating applications, for example, from one network to another. If the dependencies are broken, the application may no longer function. Or, key safety features could be disabled because of broken dependencies, making an attack against the application or underlying data easier. Thus, there is a need for application migration systems and methods that address dependencies in an efficient way and allow for migration without a loss or gap in functionality.

### SUMMARY

In some embodiments, the techniques described herein relate to a method including: collecting metadata about an application from various sources; storing the metadata in a graph structure, wherein the graph structure may be visualized using graph projections; executing a tranche function on the graph structure, wherein the tranche function outputs a plurality of tranches, and wherein each tranche of the plurality of tranches includes one or more graph nodes that represent a microservice and one or more platform service nodes that represent a platform service that is used by the microservice; providing each tranche of the plurality of tranches as input to a timeline function, wherein the timeline function outputs a delivery time for each tranche in the plurality of tranches; and aggregating the delivery time for each tranche in the plurality of tranches to generate an overall timeline for migrating, to a public cloud platform, each microservice represented by the one or more graph nodes that represent a microservice in each tranche of the plurality of tranches.

In some embodiments, the techniques described herein relate to a method including: a computer based method comprising steps of: collecting metadata from one or more data sources, the metadata including connections between a plurality of applications and one or more of a plurality of platform services; storing the metadata in a graph structure on a memory, wherein the graph structure includes a node for each application and platform service and an edge for a connection between each application and each platform service, wherein at least one of the plurality of applications is connected to at least one of the plurality of platform services; identifying a plurality of tranches of the graph structure, wherein a first tranche of the plurality of tranches includes a first application of the plurality of applications connected to a first platform service of the plurality of platform services; determining a delivery time for each tranche in the plurality of tranches; and aggregating the delivery time for each tranche in the plurality of tranches to generate an overall timeline for migrating, to a public cloud platform, each platform service.

In some embodiments, the steps may further comprise migrating each tranche of the plurality of tranches to the public cloud platform from a computer network. In some embodiments, the steps may further comprise identifying a second tranche of the plurality of tranches, the second tranche including a second tranche including a second application of the plurality of applications connected to a second platform service of the plurality of platform services, and a third application of the plurality of applications connected to the first platform service and connected to the second platform service.

In some embodiments, identifying the first tranche of the plurality of tranches may include determining the first platform service has more edges than the second platform service, wherein the first tranche is to be migrated to the public cloud platform first. In some embodiments, the step may further comprise identifying a third tranche including any of the plurality of applications that are not already placed in the first tranche or the second tranche. In some embodiments, identifying the first tranche of the plurality of tranches includes determining the first platform service has more edges than any other tranche of the plurality of tranches, wherein the first tranche is to be migrated to the public cloud platform first. In some embodiments, collecting metadata may include reading a plurality of platform Application Programming Interfaces (APIs) to determine connections between the plurality of applications and the one or more platform services.

Embodiments consistent with the present disclosure include a system comprising one or more processors and one or more storage devices storing instructions that when executed by one or more processors, cause the processor to perform one or more steps of the methods disclosed herein. Embodiments consistent with the present disclosure include a computer processing system, computer, or server, comprising: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 illustrates an exemplary knowledge graph, in accordance with embodiments.

FIG. 2A illustrates an exemplary knowledge graph configuration after a first iteration of a tranche function executed thereon, in accordance with embodiments.

FIG. 2B illustrates an exemplary knowledge graph configuration after a second iteration of a tranche function executed thereon, in accordance with embodiments.

FIG. 2C illustrates an exemplary knowledge graph configuration after a third iteration of a tranche function executed thereon, in accordance with embodiments.

FIG. 2D illustrates an exemplary knowledge graph configuration after a fourth iteration of a tranche function executed thereon, in accordance with embodiments.

FIG. 3 is a logical flow for determining an application migration plan, in accordance with embodiments.

FIG. 4 is a block diagram of a technology infrastructure and computing device for implementing certain embodiments of the present disclosure, in accordance with embodiments.

### DETAILED DESCRIPTION

Embodiments generally relate to systems and methods for determining an application migration plan.

Embodiments may include an approach that uses metadata about existing application deployments to automate the creation of architecture and planning artifacts, as well as executing the migration. Applications may include many components that may be deployed to a cloud environment or in a distributed manner across several computers. In common cloud platforms, these several components may be individual microservices that, in the aggregate, make up a complete application. Microservices and/or other components of an application may depend on free or metered services such as databases or third-party application programming interfaces (“APIs”). Applications deployed in a cloud environment may have an abundance of metadata that describe the applications and the services they depend on. By examining an application's dependent services, usage patterns of microservices may be identified. Such patterns may be employed to identify what capabilities are needed when migrating an application to another platform—such as a cloud platform provided by a public cloud provider. Embodiments may use application metadata to drive automation of planning and execution of an application cloud migration.

In accordance with embodiments, an application migration platform may begin an application migration process with a data collection process. A data collection process may use any available source of metadata with respect to an application's deployments that facilitate drawing, planning or execution of the application's migration. Such data sources include platform APIs, source control repositories, infrastructure registries, Domain Name System (“DNS”) instances, etc. Automation of such tasks may require a rich corpus of data to be collected about an application by the data collection process.

The application migration process may use a static list of data sources to gather metadata. Platform APIs may be used to discover the microservices and the potential dependencies. The static list of data sources may enrich the data received from the platform service. In some embodiments, dependencies may require different metadata sources. For example, if a microservice is using an IP address, a DNS instance may be used to determine a record name, and a classification can then be made based on the determined record name. Or, the record name can be compared against an infrastructure registry associated with a server or network to determine a dependency of the microservice.

In accordance with embodiments, data from a collection procedure may be used to visually represent a current state of an application. In some embodiments, data from a collection process may be used as input to a mutation function and mutated to demonstrate how an application's on-premises architecture may evolve during a migration to a cloud platform. This may be considered a drawing phase or process.

In accordance with embodiments, data collected in a data collection process may be used as input to a planning function. Output from a planning function may provide an estimated effort with respect to an application migration and an optimal order in which to migrate an application's components to a public cloud platform.

The estimated effort may be calculated using a list of what usage patterns a microservice is using and applying a “rate card” of weights for each pattern. The usage patterns may be a number of microservices using a database, an amount of data over time, or a total amount of data transferred to or from a database in operable connection with a microservice component. For each detected instance of an outside interaction of a microservice, the usage pattern may be categorized. For example, a microservice may communicate with multiple external internet protocols (IPs), and those will be mapped to a pattern such as “IP address1”=First Database—relational database; or “IP address2”=Second Database—messaging or streaming service. Across an application, a group of micro services may be measured to determine a demand for a particular pattern. For example, 35 microservices may include 25 of the microservices communicating with a relational database and 10 of them communicating with a streaming service, therefore there is higher demand for the relational database.

The weights in a rate card or assigned to a particular pattern may reflect a number of days required to migrate each of an application's components. For example, if a microservice is analyzed and determined to have a first database connectivity of a relational database, a second database connectivity of an event streaming platform, and a third database connectivity of a cloud-based storage, then weights may be assigned to each of the databases such as 48 hours, 24 hours, and 24 hours, respectively. The unit of time is subject to customization and may be any unit of time. The weights may be determined based on historical examples (e.g., stored on a rate card), a number of associated microservices (e.g., a ratio needed for each microservice and/or based on the type of database), a size of a database, a size of a database, an upload or download rate, and/or a result of manual input.

Embodiments of a planning function may consider several pieces of information including: a start date for a migration plan, a number of dedicated resources that will be applied to a migration plan, an amount of training and/or initial planning that will be included in a migration plan, an effort rate card that describes common patterns of an application and an amount of effort required to migrate a particular pattern, and application metadata collected by a data collection process.

In accordance with embodiments, a planning function may be divided into several logical steps including: A grouping step that groups microservices of an application based on a microservice's complexity score (where complexity can be measured through a complexity function), a prioritization function that measures and outputs demand for patterns across an application, splitting of microservices into delivery tranches based on output from a tranche function, and an estimation of effort and timeline required by each tranche provided as output of an estimating function. The types of patterns are discussed above.

As part of a grouping step, embodiments may include a complexity function that returns a complexity score for a given microservice. A complexity function may use any measure of complexity or any combination of measures, such as lines of code, dependencies, or interfaces, for example. A complexity function may consider dependent services as a way of calculating complexity, since the more services a microservice depends on, the more complex it may be and the more effort may be required for migration.

An exemplary complexity function may include the formula: complexity=Number of service dependencies. Accordingly, a microservice with 3 service dependencies may result in a complexity score output of 3.

A grouping function may construct a knowledge graph, including nodes of all microservices that are included in an application to be migrated and modes for each microservice's service dependencies. Each microservice node may be assigned a complexity score based on output form a complexity function (as described above). A grouping function may then place microservice nodes into groups with other microservices that have a same complexity score. A grouping function may return a map of complexity score keys, and collections of microservices as values.

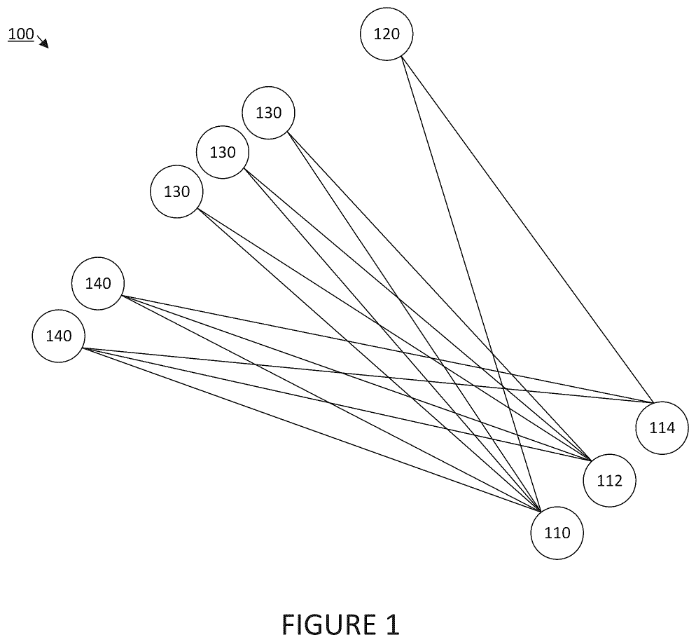

FIG. 1 depicts an exemplary knowledge graph, in accordance with embodiments. The knowledge graph of FIG. 1 may be a visual representation of a knowledge graph as described herein, where different node colors represent different groupings of microservices that are part of a n application to be migrated. Microservices with a similar complexity score are grouped together.

In accordance with embodiments, a prioritization function may score platform services based on how many applications are using them. A prioritization function may reflect, in effect, an opposing view of an application and its microservices as that offered by a complexity function. Each point on a prioritization score may be accounted for by a single point on a corresponding application's complexity score. A prioritization function may include the formula: prioritization=Number of microservices using a service. A prioritization function may be used to score platform services' usage and a prioritization score may be used as a factor in a tranche creation procedure.

The prioritization function allows applications and platform services to migrated systematically and without breaking connections between the applications and the platform services. Thus, the functionality of applications can be maintained throughout migration. The migration can also be accomplished autonomously, without requiring intensive review and correction of each application's connections to platform services after migration.

As discussed above, platform APIs may be used to determine what services a particular microservice is using. Platform APIs applied to a group of microservices that make up an application may reveal a demand for the services as a whole across the application.

Referring to FIG. 1, an exemplary knowledge graph of application 100 is illustrated. Prioritization may be visualized in the exemplary knowledge graph. Each of nodes 110, 112, and 114 represents different platform-provided-services such as one or more of an external-dependency-service (e.g., a service that may grant access to network resources that are outside of the platform), an event processing service (e.g., a messaging queue or a streaming service), a cloud platform (e.g., a catalog of services that can be used to provision resources to an application), and a database service (e.g., a relational database or a managed database). Other types of services are also contemplated including a registry, a key storage, an object storage, a configuration server, a caching service, an authorization service, and an authentication service. The services may be microservices. Microservices may be small independent services that communicate over APIs.

The prioritization may be based on a number of connections (i.e., edges) of service nodes 110, 112, 114 to application nodes 120, 130, and 140. A connection is a use of at least one platform service by at least one application. Application nodes 120, 130, and 140 may represent applications (e.g., a downloadable program that a processor executes to accomplish a function such as a media player, a banking application, a word processor, etc.). The edges may be drawn between some of application nodes 120, 130, and 140, respectively, and some of service nodes 110, 112, 114, respectively, to represent a connection or usage of a service platform associated with a service node by an application associated with an application node. More edges for a service node represents more demand.

A prioritization may be based on which service nodes have more edges. As an example, service node 110 has the highest prioritization with two edges between service node 110 and application nodes 140, three edges between service node 110 and application nodes 130, and one edge between service node 110 and application node 120 for a total of six edges. Service node 112 may have the next-highest prioritization with two edges between service node 112 and application nodes 140 and three edges between service node 112 and application nodes 130 for a total of five edges. Service node 114 may have the lowest prioritization with two edges between service node 114 and application nodes 140 and one edge between service node 114 and application node 120 for a total of three edges.

Thus, disclosed embodiments allow migration of the applications while maintaining connections to platform services. Application integrity is also maintained, which results in fewer application vulnerabilities being exploited.

The edges represent service bindings between an application and a service. Service bindings may be determined from a service broker that manages service performing duties (e.g., provisioning a required resource) and binds the microservice to the service instance. The service broker may include a database of service bindings that may be read to determine the edges.

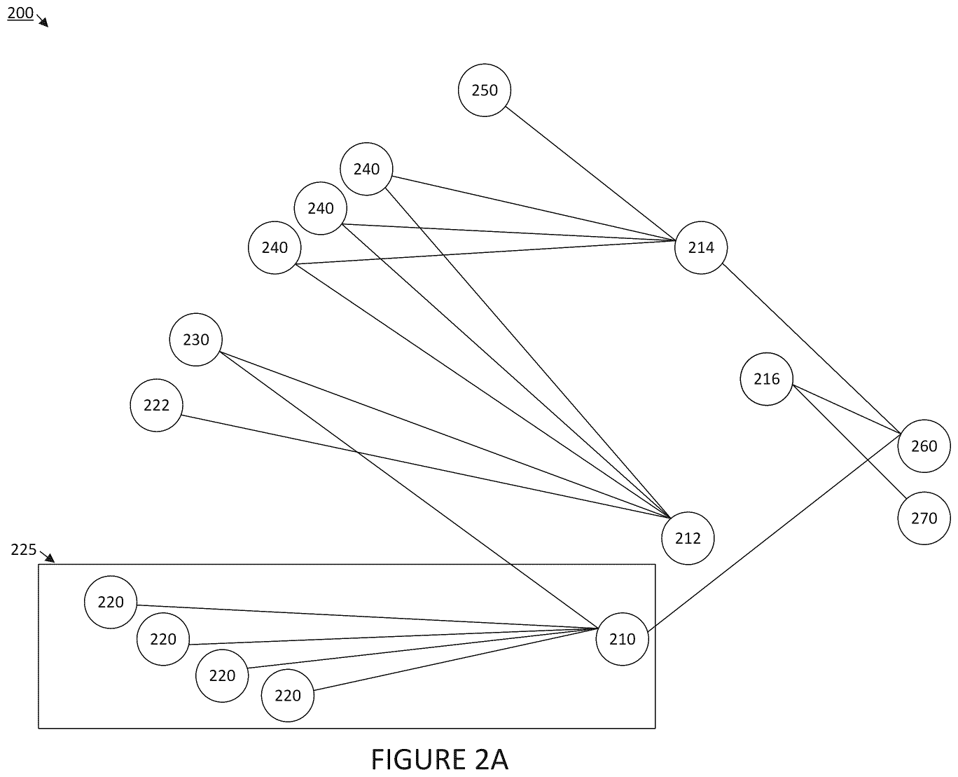

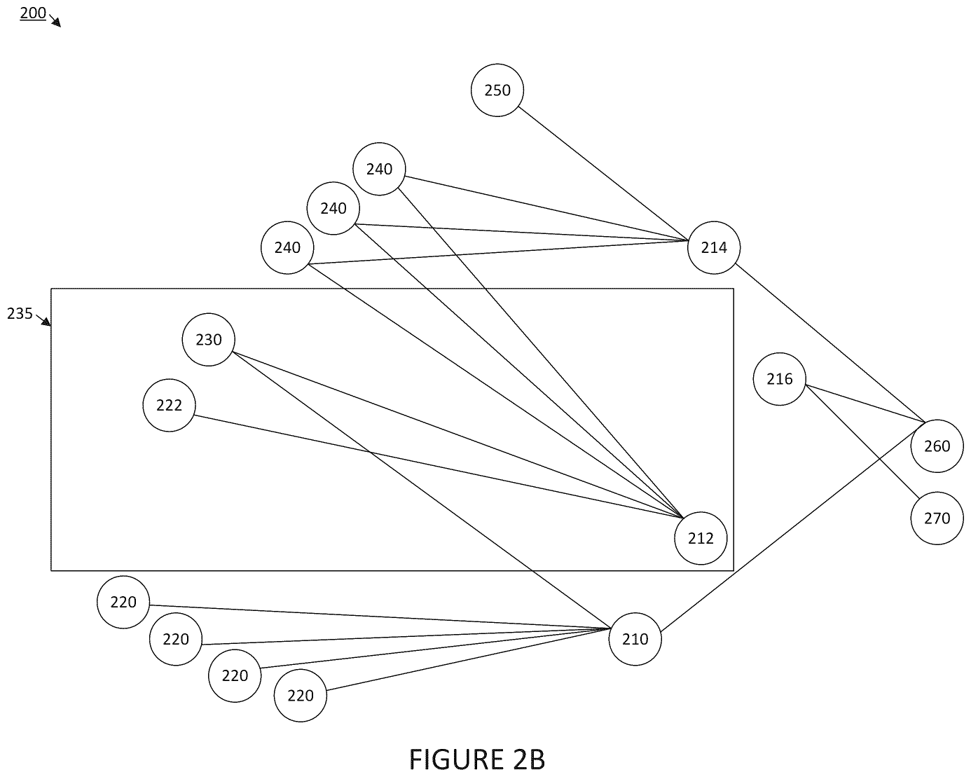

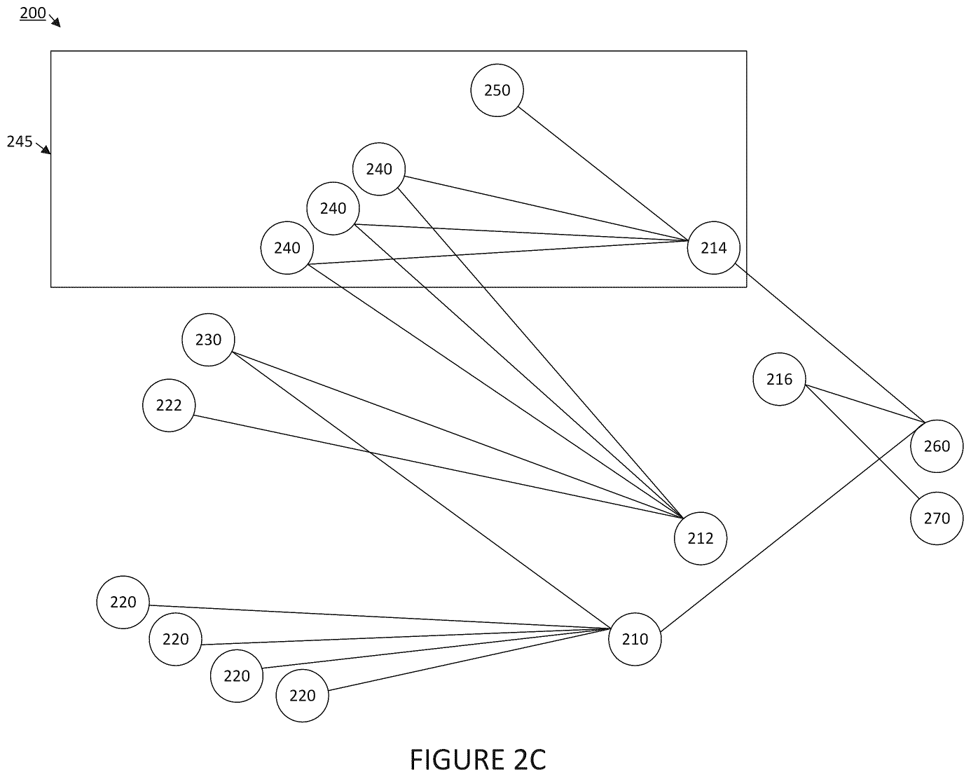

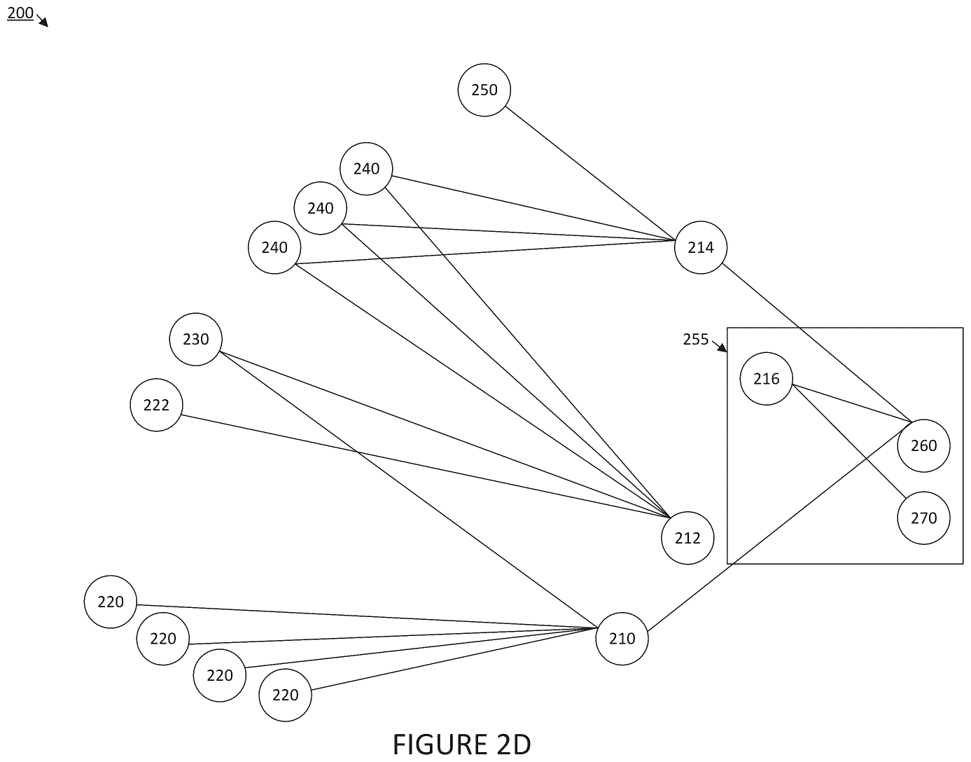

Referring to FIG. 2A, an exemplary knowledge graph of application 200 is illustrated.

Application 200 may include service nodes 210, 212, 214, and 216, similar to the service nodes described above. Application 200 may include application nodes, 220, 222, 230, 240, 250, 260, and 270, similar to the application nodes described above. A tranche function, executed by as a series of instructions stored on a memory by a processor, may include identification of a first group of applications as belonging to a first tranche 225. The tranche function may select a platform service (e.g., represented by service node 210) among other platform services, the platform service being connected to groups of applications (e.g., represented by application nodes 220) that may be efficiently migrated together. The first tranche 225 may be considered a first delivery tranche, the first delivery tranche being selected for migration to a cloud network. Migrating as disclosed herein ensures connections are maintained between applications and service nodes.

Input to a tranche function may include a group of microservices, a group of services and service prioritization scores for the services in the service groups. The prioritization may be determined as discussed above. In this case, service node 210 has the highest priority because it has six edges, which is more than service nodes 212, 214, and 216. A method signature for a tranche function may be:

tranche(groups,services,bindings,priority).

In accordance with embodiments, a tranche function may include the following logic: 1) Order the groups of services by ascending complexity. 2) For each group of microservices: 2.1) identify the platform services in use by the group; 2.2) select the top N in-use platform services that have the highest prioritization score and add them to a set of solved platform services, where N is the 1-based group index of the current group of microservices; and 2.3) identify the microservices that are not already placed in a tranche, that are dependent on only the set of solved platform services and create a new tranche containing these microservices and add this new tranche to the list of tranches. 3) Return the list of tranches containing apps to migrate in each tranche.

For the tranche function, the solved platform service is a platform service marked as solved for by a previous tranche. For example, during a cloud migration you may need to define how services will be migrated. If a first tranche 225 is prioritized as discussed above, the first tranche 225 would be migrated first, including only applications (e.g., represented by application nodes 220) that use the service (e.g., represented by service node 210) exclusively, because the other services (e.g., represented by service nodes 212, 214, 216) are not yet “solved for.”

After the first tranche 225 is migrated, the first tranche 225 is marked as solved and thus becomes a “solved platform service.” The next service (discussed below with reference to FIG. 2B) then becomes the next service to be migrated, and so on.

Referring to FIG. 2B, an exemplary knowledge graph of application 200 is illustrated.

The tranche function discussed above may continue and may include identification of a second group of applications as belonging to a second tranche 235. The tranche function may select a second platform service, a service represented by service node 212, to include groups of applications (e.g., represented by application nodes 222, 230) that may be efficiently migrated together. The second tranche 235 may be considered a second delivery tranche. As shown, the groups of application to be migrated in the second tranche 235 may include those using a service represented by service node 212 including an application represented by application node 222. The groups of application to be migrated in the second tranche 235 may include those using a service represented by service node 212 as well as the applications using the service represented by service node 210, including an application represented by application node 230.

Referring to FIG. 2C, an exemplary knowledge graph of application 200 is illustrated.

The tranche function discussed above may continue and may include identification of a third group of applications as belonging to a third tranche 245. The tranche function may select a third platform service, a service represented by service node 214, to include groups of applications (e.g., represented by application nodes 240, 250) that may be efficiently migrated together. The third tranche 245 may be considered a third delivery tranche. As shown, the groups of application to be migrated in the third tranche 245 may include those applications exclusively using a service represented by a service represented by service node 214 including an application represented by application node 250. The groups of application to be migrated in the third tranche 245 may include those using a service represented by service node 214 as well as the applications using a service represented by service node 212, including applications represented by application nodes 240.

Referring to FIG. 2D, an exemplary knowledge graph of application 200 is illustrated.

The tranche function discussed above may continue and may include identification of a fourth group of applications as belonging to a fourth tranche 255. The tranche function may select a fourth platform service, a service represented by service node 216, to include groups of applications (e.g., represented by application nodes 260, 270) that may be efficiently migrated together. The fourth tranche 255 may be considered a fourth delivery tranche. As shown, the groups of application to be migrated in the fourth tranche 255 may include those exclusively using a service represented by service node 216 including an application represented by application node 270. The groups of application to be migrated in the third tranche 245 may include those using a service represented by service node 216 as well as the applications using services represented by service nodes 214, 210, including applications represented by application nodes 260.

In accordance with embodiments, creation of delivery tranches may create a lineal model of what microservices may be migrated together and in what order those migrations should take place. A timeline algorithm may estimate how long each tranche will take and tranche timelines may be aggregated to provide a delivery timeline. A timeline algorithm may be included in a tranche function, or may be a stand-alone function.

In accordance with embodiments, a timeline method signature of a timeline function may be:

timeline(tranches:List<Tranche>,systemCount:Number,start:Date,trainingBufferWeeks: Number).

Moreover, a timeline function may include an estimation function, such as:

estimate(x,y)=>The number of system-time effort required to migrate x, using rate card y.

The rate card of the estimation function may be a map of patterns to system-time effort estimations. For example, if a microservice uses a pattern such as key management, the rate card may map such a key management migration to 5 system-time worth of effort. For example, system time may be measured in minutes, hours, or days. The estimation function may look up each pattern a microservice is identified as using and may build its total estimate from the sum of rate card entries that match determined patterns. A timeline estimate for a given tranche may be the sum of all estimates for the microservices in that tranche. In some embodiments, time may be apportioned due to experience with planning similar services for other systems or as otherwise discussed above.

System-effort values may then be converted to elapsed time by using the number of systems denoted as applied to the migration effort and a time period, such as minutes, hours, or days. This calculation may then be plotted on a timeline starting with the supplied start date. Output may include a detailed timeline that can be adjusted by an end user to allow for parallel workstreams.

In accordance with embodiments, metadata gathered in the collection phase in combination with access to source control repositories may facilitate automation of the development tasks and code changes required as part of a migration, including automatic generation of infrastructure as code artifacts or network configuration to help simplify the tasks of migration to a public cloud platform.

Moreover, data collected in the collection phase may be used for identifying patterns or validating architectures by being periodically evaluated for architectural drift detection. Architectural drift detection refers to a process that identifies that a given architecture (e.g., Architecture X) has drifted and/or evolved, over time, into a different architecture (e.g., Architecture Y). Periodic data collections may provide a real-time view of architecture without the need to have architects manually updating diagrams and associated documentation.

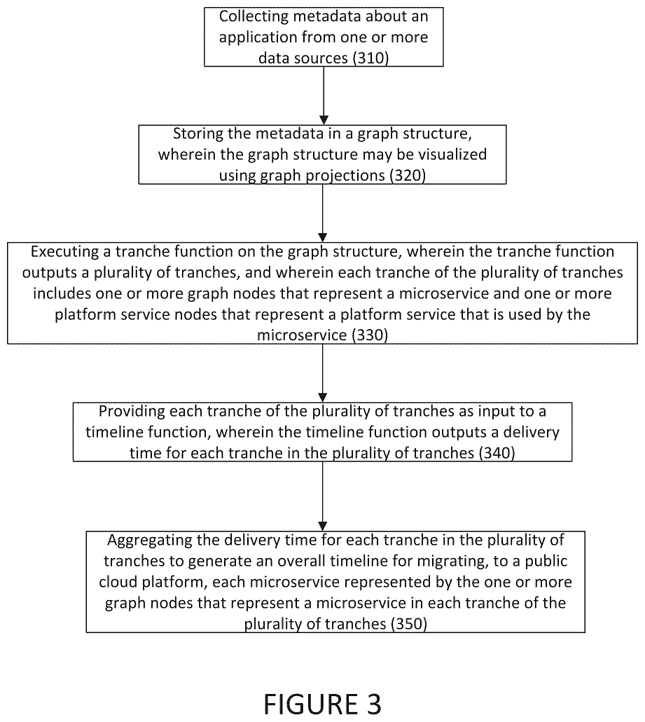

FIG. 3 is a logical flow for determining an application migration plan, in accordance with embodiments.

In step 310, a migration application performing an application migration plan may include a set of instructions stored on a memory and executed by a processor, where the migration application may be configured to collect metadata about a plurality of applications on a computer network, the plurality of applications using one or more data sources. An application may comprise code to handle a specific task. For example, the application may be a word processor, a banking application, or a media player. A data source may be a location such as a local memory or cloud-based memory where data originates from.

The metadata may include which of the plurality of applications use which data sources and which platform services. Platform services may include provisioning, instantiating, running, and managing portions of applications. For example, platform services may include data storage, file sharing, data governance, analytics, and/or security services. The application may determine which of the plurality of applications use which platform services based on the data sources. For example, the data sources may include a record of connections between platform services and applications including through a record of use of APIs, a record of transferred data, or a code that references a platform service. The data sources may include a memory used by the application in the course of the application's functions, such as by storing data, files, scripts, registries, repositories, or similar. The metadata may include which of the plurality of applications use one or more platform services. The platforms and/or applications may be similar to those discussed above.

In some embodiments, the data sources may be part of a computer network. The computer network may be a local area network, an organizational network of connected computers, an on-premises network of computers.

In step 320, the migration application may store the metadata in a graph structure on a memory, wherein the graph structure may be visualized from the metadata including each of the applications, platform services, and connections within the metadata. The graph structure may be a representation of the metadata. The graph structure may include nodes representing each application, at least one node representing a platform service, and an edge connecting at least one platform service to at least one application of the plurality of applications.

In step 330, the migration application may execute a tranche function on the graph structure, wherein the tranche function outputs a plurality of tranches. FIGS. 2A-2D discussed above show groupings of an exemplary set of applications, platform services, and connections between applications and platform services, according to the tranche function. Each tranche of the plurality of tranches may include at least one application node, at least one platform service. The tranche function may prioritize a first platform service node selected based on a largest number of edges of a platform service node of the plurality of platform service nodes. The prioritization is discussed above with reference to FIG. 1 as well as FIGS. 2A-2D. The tranche function may group a second platform service node with the second-largest number of edges and any applications exclusively using the second platform service node as well as any application using the first platform service and the second platform service node. FIGS. 2A-2D discussed above show groupings of an exemplary set of applications, platform services, and connections between applications and platform services, according to the tranche function. The tranche function may continue to select tranches for migration as discussed above.

In step 340, the migration application may provide each tranche of the plurality of tranches as input to a timeline function, wherein the timeline function outputs a delivery time for each tranche in the plurality of tranches. The delivery time may be based on one or more of a type of platform service in each tranche, a data size used by each platform service, a size of one or more data sources associated with each application and/or platform service, a number of applications associated with each platform service, and a bandwidth. For example, a first tranche may take five days and a second tranche may take three days, and the timeline function may show how long each tranche takes. The determination of the number of days may be based on the type of platform service (e.g., security, data management, etc.) or a data size associated with the platform service (e.g., an amount of data in bytes accessed by the platform service).

In step 350, the migration application may aggregate the delivery time for all tranches. An overall timeline for migrating all tranches to a public cloud platform may be generated. Using the example above, the migration may take eight days.

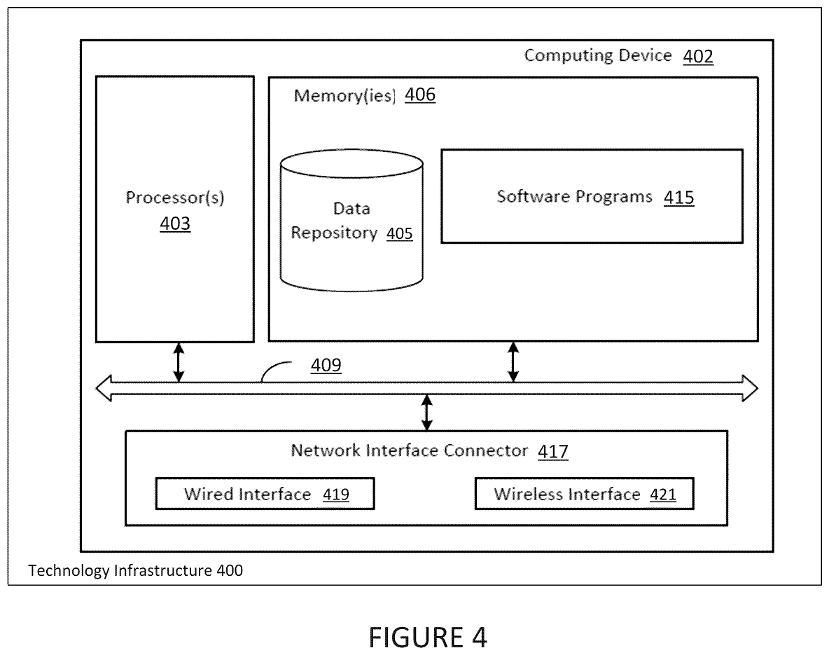

FIG. 4 is a block diagram of a technology infrastructure and computing device for implementing certain embodiments of the present disclosure, in accordance with embodiments. FIG. 4 includes technology infrastructure 400. Technology infrastructure 400 represents the technology infrastructure of an implementing organization. Technology infrastructure 400 may include hardware such as servers, client devices, and other computers or processing devices. Technology infrastructure 400 may include software (e.g., computer) applications that execute on computers and other processing devices. Technology infrastructure 400 may include computer network mediums, and computer networking hardware and software for providing operative communication between computers, processing devices, software applications, procedures and processes, and logical flows and steps, as described herein.

Exemplary hardware and software that may be implemented in combination where software (such as a computer application) executes on hardware. For instance, technology infrastructure 400 may include webservers, application servers, database servers and database engines, communication servers such as email servers and SMS servers, client devices, etc. The term “service” as used herein may include software that, when executed, receives client service requests and responds to client service requests with data and/or processing procedures. A software service may be a commercially available computer application or may be a custom-developed and/or proprietary computer application. A service may execute on a server. The term “server” may include hardware (e.g., a computer including a processor and a memory) that is configured to execute service software. A server may include an operating system optimized for executing services. A service may be a part of, included with, or tightly integrated with a server operating system. A server may include a network interface connection for interfacing with a computer network to facilitate operative communication between client devices and client software, and/or other servers and services that execute thereon.

Server hardware may be virtually allocated to a server operating system and/or service software through virtualization environments, such that the server operating system or service software shares hardware resources such as one or more processors, memories, system buses, network interfaces, or other physical hardware resources. A server operating system and/or service software may execute in virtualized hardware environments, such as virtualized operating system environments, application containers, or any other suitable method for hardware environment virtualization.

Technology infrastructure 400 may also include client devices. A client device may be a computer or other processing device including a processor and a memory that stores client computer software and is configured to execute client software. Client software is software configured for execution on a client device. Client software may be configured as a client of a service. For example, client software may make requests to one or more services for data and/or processing of data. Client software may receive data from, e.g., a service, and may execute additional processing, computations, or logical steps with the received data. Client software may be configured with a graphical user interface such that a user of a client device may interact with client computer software that executes thereon. An interface of client software may facilitate user interaction, such as data entry, data manipulation, etc., for a user of a client device.

A client device may be a mobile device, such as a smart phone, tablet computer, or laptop computer. A client device may also be a desktop computer, or any electronic device that is capable of storing and executing a computer application (e.g., a mobile application). A client device may include a network interface connector for interfacing with a public or private network and for operative communication with other devices, computers, servers, etc., on a public or private network.

Technology infrastructure 400 includes network routers, switches, and firewalls, which may comprise hardware, software, and/or firmware that facilitates transmission of data across a network medium. Routers, switches, and firewalls may include physical ports for accepting physical network medium (generally, a type of cable or wire—e.g., copper of fiber optic wire/cable) that forms a physical computer network. Routers, switches, and firewalls may also have “wireless” interfaces that facilitate data transmissions via radio waves. A computer network included in technology infrastructure 400 may include both wired and wireless components and interfaces and may interface with servers and other hardware via either wired or wireless communications. A computer network of technology infrastructure 400 may be a private network but may interface with a public network (such as the internet) to facilitate operative communication between computers executing on technology infrastructure 400 and computers executing outside of technology infrastructure 400.

FIG. 4 further depicts exemplary computing device 402. Computing device 402 depicts exemplary hardware that executes the logic that drives the various system components described herein. Servers and client devices may take the form of computing device 402. While shown as internal to technology infrastructure 400, computing device 402 may be external to technology infrastructure 400 and may be in operative communication with a computing device internal to technology infrastructure 400.

In accordance with embodiments, system components such as a graph data structures, client devices, servers, various database engines and database services, and other computer applications and logic may include, and/or execute on, components and configurations the same, or similar to, computing device 402.

Computing device 402 includes a processor 403 coupled to a memory 406. Memory 406 may include volatile memory and/or persistent memory. The processor 403 executes computer-executable program code stored in memory 406, such as software programs 415. Software programs 415 may include one or more of the logical steps disclosed herein as a programmatic instruction, which can be executed by processor 403. Memory 406 may also include data repository 405, which may be nonvolatile memory for data persistence. The processor 403 and the memory 406 may be coupled by a bus 409. In some examples, the bus 409 may also be coupled to one or more network interface connectors 417, such as wired network interface 419, and/or wireless network interface 421. Computing device 402 may also have user interface components, such as a screen for displaying graphical user interfaces and receiving input from the user, a mouse, a keyboard and/or other input/output components (not shown).

In accordance with embodiments, services, modules, engines, etc., described herein may provide one or more application programming interfaces (APIs) in order to facilitate communication with related/provided computer applications and/or among various public or partner technology infrastructures, data centers, or the like. APIs may publish various methods and expose the methods, e.g., via API gateways. A published API method may be called by an application that is authorized to access the published API method. API methods may take data as one or more parameters or arguments of the called method. In some embodiments, API access may be governed by an API gateway associated with a corresponding API. In some embodiments, incoming API method calls may be routed to an API gateway and the API gateway may forward the method calls to internal services/modules/engines that publish the API and its associated methods.

A service/module/engine that publishes an API may execute a called API method, perform processing on any data received as parameters of the called method, and send a return communication to the method caller (e.g., via an API gateway). A return communication may also include data based on the called method, the method's data parameters and any performed processing associated with the called method.

API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

The various processing steps, logical steps, and/or data flows depicted in the figures and described in greater detail herein may be accomplished using some or all of the system components also described herein. In some implementations, the described logical steps or flows may be performed in different sequences and various steps may be omitted. Additional steps may be performed along with some, or all of the steps shown in the depicted logical flow diagrams. Some steps may be performed simultaneously. Some steps may be performed using different system components. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing device,” a “computing device,” a “computer,” an “electronic device,” a “mobile device,” a “client device,” a “server,” etc. As used herein, these terms (unless otherwise specified) are to be understood to include at least one processor that uses at least one memory. The at least one memory may store a set of instructions. The instructions may be either permanently or temporarily stored in the memory or memories of the processing device. The processor executes the instructions that are stored in the memory or memories in order to process data. A set of instructions may include various instructions that perform a particular step, steps, task, or tasks, such as those steps/tasks described above, including any logical steps or logical flows described above. Such a set of instructions for performing a particular task may be characterized herein as an application, computer application, program, software program, service, or simply as “software.” In one aspect, a processing device may be or include a specialized processor. As used herein (unless otherwise indicated), the terms “module,” and “engine” refer to a computer application that executes on hardware such as a server, a client device, etc. A module or engine may be a service.

As noted above, the processing device executes the instructions that are stored in the memory or memories to process data. This processing of data may be in response to commands by a user or users of the processing device, in response to previous processing, in response to a request by another processing device and/or any other input, for example. The processing device used to implement the invention may utilize a suitable operating system, and instructions may come directly or indirectly from the operating system.

The processing device used to implement the invention may be a general-purpose computer. However, the processing device described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing device be physically located in the same geographical place. That is, each of the processors and the memories used by the processing device may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing device what to do with the data being processed.

Further, it is appreciated that the instructions or set of instructions used in the implementation and operation of the invention may be in a suitable form such that the processing device may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing device, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing device, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing device, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing device that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing device or machines that are used to implement the invention. As used herein, a user interface includes any hardware, software, or combination of hardware and software used by the processing device that allows a user to interact with the processing device. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing device as it processes a set of instructions and/or provides the processing device with information. Accordingly, the user interface is any device that provides communication between a user and a processing device. The information provided by the user to the processing device through the user interface may be in the form of a command, a selection of data, or some other input, for example.

As discussed above, a user interface is utilized by the processing device that performs a set of instructions such that the processing device processes data for a user. The user interface is typically used by the processing device for interacting with a user either to convey information or receive information from the user. However, it should be appreciated that in accordance with some embodiments of the system and method of the invention, it is not necessary that a human user actually interact with a user interface used by the processing device of the invention. Rather, it is also contemplated that the user interface of the invention might interact, i.e., convey and receive information, with another processing device, rather than a human user. Accordingly, the other processing device might be characterized as a user. Further, it is contemplated that a user interface utilized in the system and method of the invention may interact partially with another processing device or processing devices, while also interacting partially with a human user.

It will be readily understood by those persons skilled in the art that the present invention is susceptible to broad utility and application. Many embodiments and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

1. A computer based method comprising steps of:
collecting metadata from one or more data sources, the metadata including connections between a plurality of applications and one or more of a plurality of platform services, wherein a connection is a use of at least one platform service by at least one application;
storing the metadata in a graph structure on a memory, wherein the graph structure includes a node for each application and each platform service and an edge for the connection between at least one application of the plurality of applications and at least one platform service of the plurality of platform services;
identifying a plurality of tranches of the graph structure, wherein a first tranche of the plurality of tranches includes a first application of the plurality of applications connected to a first platform service of the plurality of platform services;
determining a delivery time for each tranche in the plurality of tranches; and
aggregating the delivery time for each tranche in the plurality of tranches to generate an overall timeline for migrating, to a public cloud platform, each platform service.

2. The method of claim 1, further comprising migrating each tranche of the plurality of tranches to the public cloud platform from a computer network.

3. The method of claim 1, wherein the plurality of tranches further includes a second tranche including a second application of the plurality of applications connected to a second platform service of the plurality of platform services, and a third application of the plurality of applications connected to the first platform service and connected to the second platform service.

4. The method of claim 3, wherein identifying the first tranche of the plurality of tranches includes determining the first platform service has more edges than the second platform service, wherein the first tranche is to be migrated to the public cloud platform first.

5. The method of claim 3, further comprising identifying a third tranche including any of the plurality of applications that are not already placed in the first tranche or the second tranche.

6. The method of claim 1, wherein identifying the first tranche of the plurality of tranches includes determining the first platform service has more edges than any other tranche of the plurality of tranches, wherein the first tranche is to be migrated to the public cloud platform first.

7. The method of claim 1, wherein collecting metadata includes reading a plurality of platform Application Programming Interfaces (APIs) to determine connections between the plurality of applications and the one or more platform services.

8. A computer processing system comprising:
a memory configured to store instructions; and
a hardware processor operatively coupled to the memory for executing the instructions to:
collect metadata from one or more data sources, the metadata including a plurality of connections between a plurality of applications and one or more of a plurality of platform services, wherein a connection of the plurality of connections is a use of at least one platform service by at least one application;
store the metadata in a graph structure on a memory, wherein the graph structure includes a node for each application and each platform service and an edge for the connection between at least one application of the plurality of applications and at least one platform service of the plurality of platform services;
identify a plurality of tranches of the graph structure, wherein a first tranche of the plurality of tranches includes a first application of the plurality of applications connected to a first platform service of the plurality of platform services;
determine a delivery time for each tranche in the plurality of tranches; and
aggregate the delivery time for each tranche in the plurality of tranches to generate an overall timeline for migrating, to a public cloud platform, each platform service.

9. The system of claim 8, the instructions further comprising migrating each tranche of the plurality of tranches to the public cloud platform from a computer network.

10. The system of claim 8, wherein the plurality of tranches further includes a second tranche including a second application of the plurality of applications connected to a second platform service of the plurality of platform services, and a third application of the plurality of applications connected to the first platform service and connected to the second platform service.

11. The system of claim 10, wherein identifying the first tranche of the plurality of tranches includes determining the first platform service has more edges than the second platform service, wherein the first tranche is to be migrated to the public cloud platform first.

12. The system of claim 10, further comprising identifying a third tranche including any of the plurality of applications that are not already placed in the first tranche or the second tranche.

13. The system of claim 8, wherein identifying the first tranche of the plurality of tranches includes determining the first platform service has more edges than any other tranche of the plurality of tranches, wherein the first tranche is to be migrated to the public cloud platform first.

14. The system of claim 8, wherein collecting metadata includes reading a plurality of platform Application Programming Interfaces (APIs) to determine connections between the plurality of applications and the one or more platform services.

15. A non-transitory computer readable storage medium, including instructions stored thereon, which when read and executed by one or more computer processors, cause the one or more computer processors to perform steps comprising:
collecting metadata from one or more data sources, the metadata including connections between a plurality of applications and one or more of a plurality of platform services, wherein a connection of the plurality of connections is a use of at least one platform service by at least one application;
storing the metadata in a graph structure on a memory, wherein the graph structure includes a node for each application and each platform service and an edge for the connection between at least one application of the plurality of applications and at least one platform service of the plurality of platform services;
identifying a plurality of tranches of the graph structure, wherein a first tranche of the plurality of tranches includes a first application of the plurality of applications that connected to a first platform service of the plurality of platform services;
determining a delivery time for each tranche in the plurality of tranches; and
aggregating the delivery time for each tranche in the plurality of tranches to generate an overall timeline for migrating, to a public cloud platform, each platform service.

16. The non-transitory computer readable storage medium of claim 15, the steps further comprising migrating each tranche of the plurality of tranches to the public cloud platform from a computer network.

17. The non-transitory computer readable storage medium of claim 15, wherein the plurality of tranches further includes a second tranche including a second application of the plurality of applications connected to a second platform service of the plurality of platform services, and a third application of the plurality of applications connected to the first platform service and connected to the second platform service.

18. The non-transitory computer readable storage medium of claim 17, wherein identifying the first tranche of the plurality of tranches includes determining the first platform service has more edges than the second platform service, wherein the first tranche is to be migrated to the public cloud platform first.

19. The non-transitory computer readable storage medium of claim 17, further comprising identifying a third tranche including any of the plurality of applications that are not already placed in the first tranche or the second tranche.

20. The non-transitory computer readable storage medium of claim 15, wherein identifying the first tranche of the plurality of tranches includes determining the first platform service has more edges than any other tranche of the plurality of tranches, wherein the first tranche is to be migrated to the public cloud platform first.
